(19) United States
(12) Patent Application Publication
(10) Pub. No.: US 2014/0069239 A1
(43) Pub. Date: Mar. 13, 2014

(54) CURVED-TYPE ADJUSTABLE WRENCH

(71) Applicant: LI-TU LIN WU, TAICHUNG (TW)

(72) Inventor: LI-TU LIN WU, TAICHUNG (TW)

(21) Appl. No.: 13/611,184

(22) Filed: Sep. 12, 2012

(51) Int. Cl. B25B 23/16; B25B 13/16

(52) U.S. Cl. 81/170

(57) ABSTRACT

A curved-type adjustable wrench has a handle and an operating head. The handle is curved and has a hanging hole with a center point. The operating head is formed on and protrudes from the handle opposite to the hanging hole and has a fixed jaw, a movable jaw and a thumbscrew. The fixed jaw has a vertical plane, a sliding slot, an opening hole and an operating face. The movable jaw is movably connected to the fixed jaw, faces the operating face and has an engaging rod. The thumbscrew is rotatably mounted in the opening hole of the fixed jaw and extends into the sliding slot to engage the engaging rod. An angle between the operating face of the fixed jaw and the handle is 25˜40°.

### BACKGROUND OF THE INVENTION

1. Field of the Invention

The present invention relates to an adjustable wrench, and more particularly to a curved-type adjustable wrench that can be operated conveniently.

2. Description of Related Art

Reference to FIG. 4, a conventional adjustable wrench 40 is used to rotate bolts of different sizes and has two ends, a head 41 and a handle 42. The head 41 and the handle 42 are respectively formed on the ends of the conventional adjustable wrench 40 and are formed with each other. The head 41 has a fixed jaw 43, a movable jaw 44 moved connected to the fixed jaw 42 and a thumbscrew 45 rotatably mounted in the fixed jaw 43 and engaging the movable jaw 44. The fixed jaw 43 further has two sides and an opening hole 431 formed through the sides of the fixed jaw 43 to enable the thumbscrew 45 to rotatably mount in the fixed jaw 43. Then, a user can rotate the thumbscrew 45 from the opening 431 of the fixed jaw 43 to adjust the distance between the fixed jaw 43 and the movable jaw 44, and this enable the conventional adjustable wrench 40 to rotate bolts of different sizes.

The handle 42 of the conventional adjustable wrench 40 is straight and has a hanging hole 421 formed through the handle 42 at an end opposite to the head 41 and having a center point 422. A horizontal extending line extends along a side of the opening hole 431 and is intersected with a vertical face of the fixed jaw 43 to form an intersection point 432 as shown in FIG. 4. An included angle is formed between the horizontal extending line and a line that is formed between the intersection point 432 and the center point 422 of the hanging hole 421. Because the horizontal extending line parallels with an operating face 433 of the fixed jaw 43, an angel between the operating face 433 of the fixed jaw 43 and the handle 42 is same as the included angle between the horizontal extending line and the line that is formed between the intersection point 432 and the center point 422 of the hanging hole 421. Furthermore, the included angle is about 22.5°.

However, the conventional adjustable wrench 40 can be used to rotate bolts and nuts of different sizes, the angle between the operating face 433 of the fixed jaw 43 and the handle 42 is fixed and cannot be adjusted. When the conventional adjustable wrench 40 needs to rotate a bolt or nut in a narrow space, the handle 42 of the conventional adjustable wrench 40 may be interfered by the components surrounding the bolt or nut and cannot rotate the bolt or nut conveniently.

To overcome the shortcomings, the present invention provides a curved-type adjustable wrench to mitigate or obviate the aforementioned problems.

### SUMMARY OF THE INVENTION

The main objective of the present invention is to provide a curved-type adjustable wrench that can rotate a bolt or nut in a narrow space conveniently.

The curved-type adjustable wrench in accordance with the present invention has a handle and an operating head. The handle is curved and has a hanging hole with a center point. The operating head is formed on and protrudes from the handle opposite to the hanging hole and has a fixed jaw, a movable jaw and a thumbscrew. The fixed jaw has a vertical plane, a sliding slot, an opening hole and an operating face. The movable jaw is movably connected to the fixed jaw, faces the operating face and has an engaging rod. The thumbscrew is rotatably mounted in the opening hole of the fixed jaw and extends into the sliding slot to engage the engaging rod. An angel between the operating face of the fixed jaw and the handle is 25˜40°.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a curved-type adjustable wrench in accordance with the present invention;

FIG. 2 is a side view of the curved-type adjustable wrench in FIG. 1;

FIG. 3 is a cross section side view of the curved-type adjustable wrench in FIG. 2; and

FIG. 4 is a side view of an adjustable wrench in accordance with the prior art.

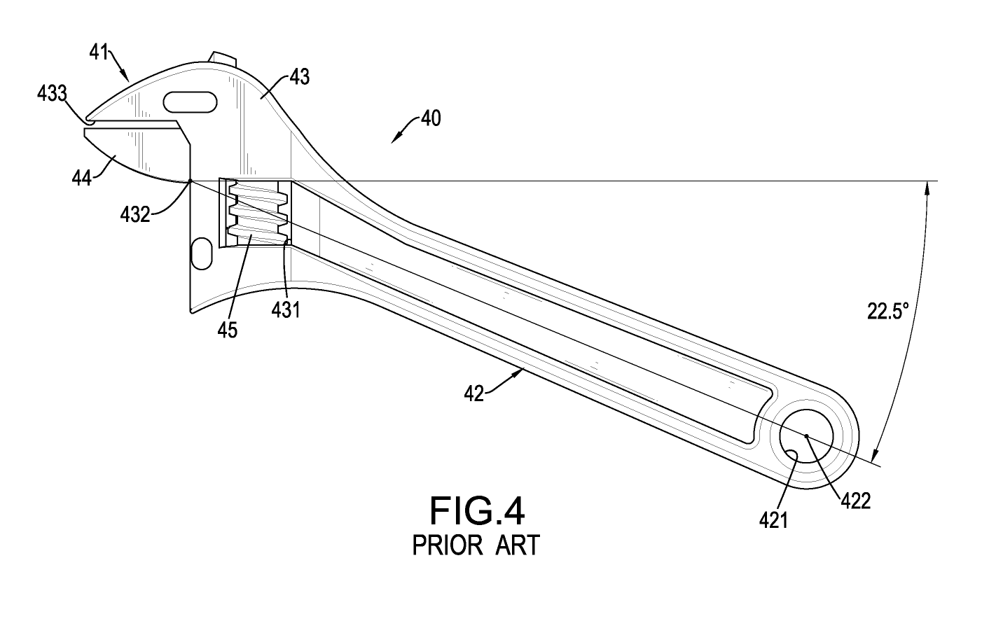

### DETAILED DESCRIPTION OF THE PREFERRED EMBODIMENT

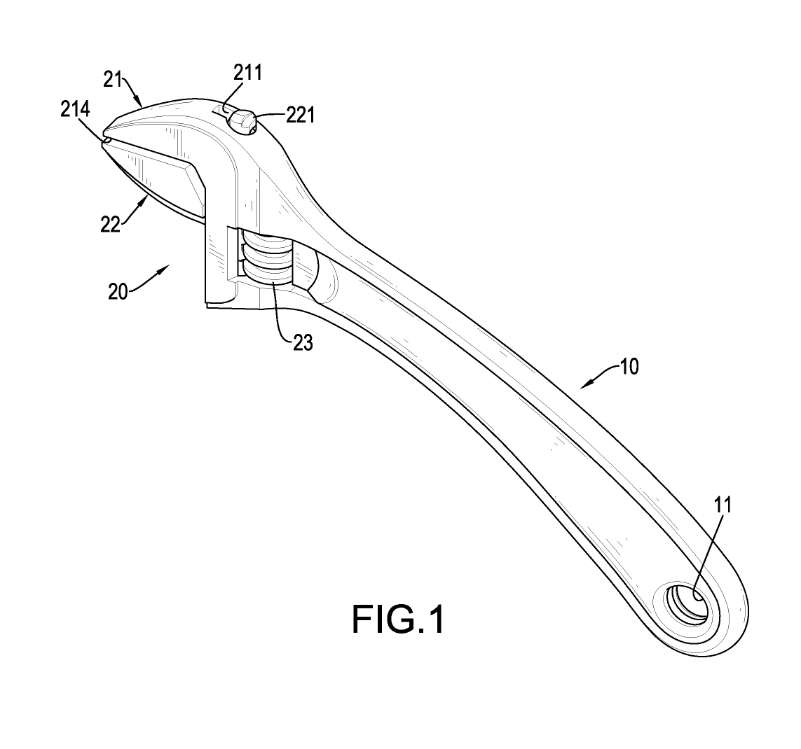

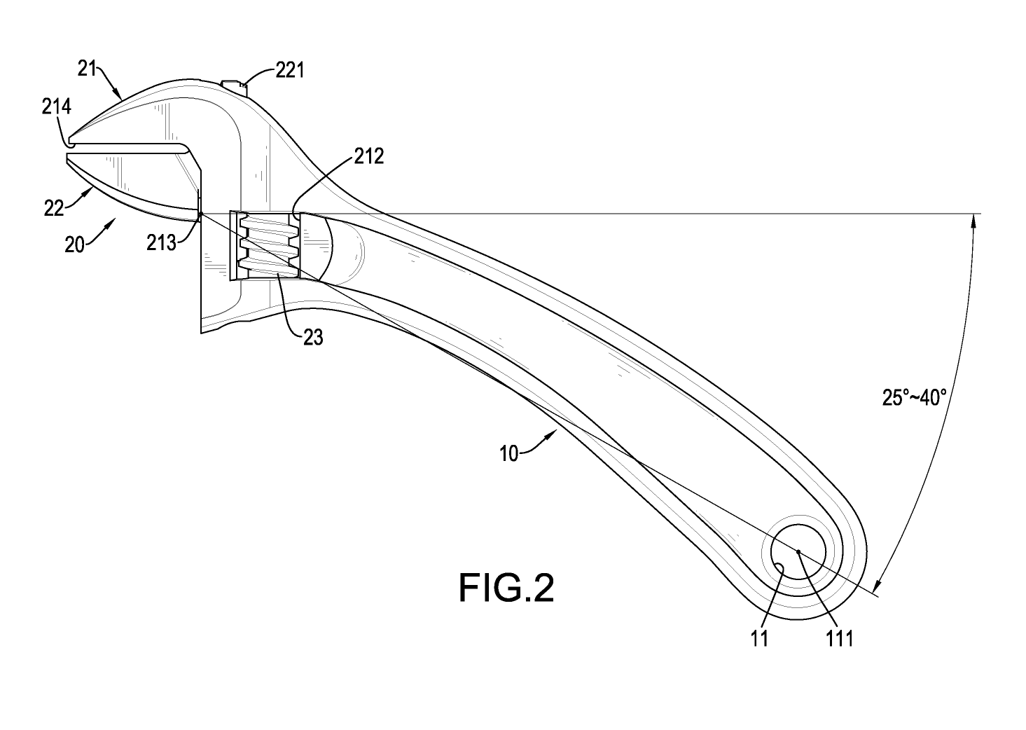

With reference to FIGS. 1 and 2, a curved-type adjustable wrench in accordance with the present invention comprises a handle 10 and an operating head 20.

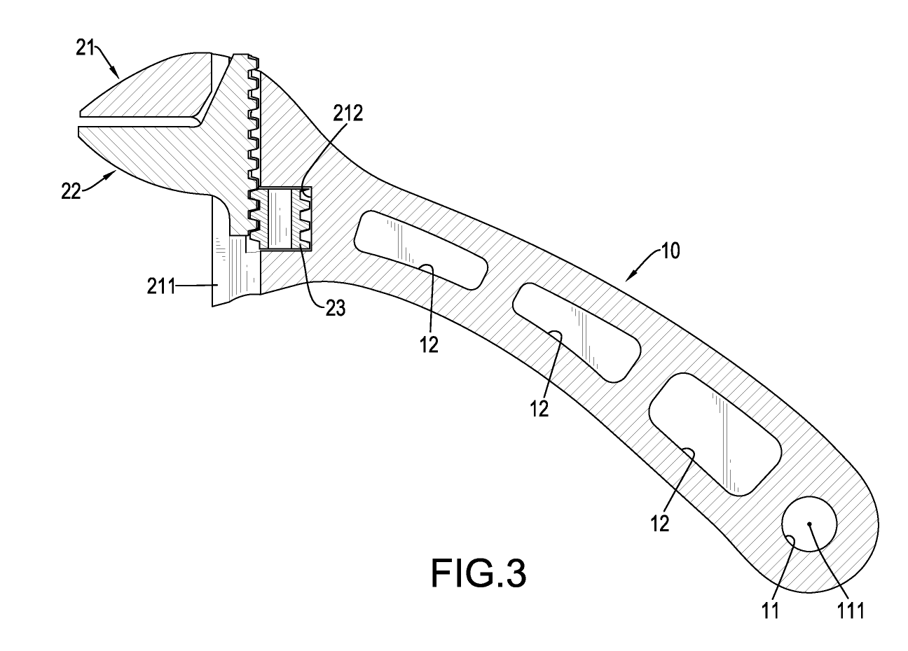

The handle 10 is curved and has a first end, a second end and a hanging hole 11. The hanging hole 11 is formed through the first end of the handle 10 and has a center point 111. With reference to FIG. 3, the handle 10 further has multiple recesses 12 formed in the handle 10 at intervals between the ends of the handle 10 to reduce the whole weight of the handle 10.

The operating head 20 is formed on and protrudes from the second end of the handle 10 opposite to the hanging hole 11 and has a fixed jaw 21, a movable jaw 22 and a thumbscrew 23. The fixed jaw 21 is formed on and protrudes from the second end of the handle 10 and has a top, a bottom, a vertical plane, an inner side, two side faces, a sliding slot 211, an opening hole 212 and an operating face 214. The sliding slot 211 is formed in the vertical plane of the fixed jaw 21 and is formed through the top and the bottom of the fixed jaw 21. The opening hole 212 is quadrate, is formed though the side faces of the fixed jaw 21 and communicates with the sliding slot 211 and has a side. The operating face 214 is formed on the inner side of the fixed jaw 21, is perpendicular to the vertical plane of the fixed jaw 21 and parallels with the side of the opening hole 212.

The movable jaw 22 is movably connected to the fixed jaw 21, faces the operating face 214 of the fixed jaw 21 and has a rear side and an engaging rod 221. The engaging rod 221 is formed on and protrudes from the rear side of the movable jaw 22 and is sliding mounted in the sliding slot 211 of the fixed jaw 21.

The thumbscrew 23 is rotatably mounted in the opening hole 212 of the fixed jaw 21 and extends into the sliding slot 211 to engage the engaging rod 221 of the movable jaw 22 to adjust the distance between the fixed jaw 21 and the movable jaw 22.

With further reference to FIG. 2, a horizontal extending line extends along the side of the opening hole 212 of the fixed jaw 21, parallels with the operating face of the fixed jaw 21 and is intersected with the vertical plane of the fixed jaw 21 to form an intersection point 213. An included angle is formed between the horizontal extending line and a line that is formed between the intersection point 213 and the center point 111 of the hanging hole 11. Because the horizontal extending line parallels with the operating face 214 of the fixed jaw 21, an angel between the operating face 214 of the fixed jaw 21 and the handle 10 is same as the included angle between the horizontal extending line and the line that is formed between the intersection point 213 and the center point 111 of the hanging hole 11 and is 25˜40°.

When the conventional adjustable wrench 40 cannot be used to rotate a bolt or a nut in a narrow space, the curved-type adjustable wrench in accordance with the present invention can be used to rotate the bolt or nut in the narrow space conveniently without interfering with the surrounding components due to the angle (25˜40°) between the operating face 214 of the fixed jaw 21 and the handle 10 is larger than the angle (22.5°) between the operating face 433 of the fixed jaw 43 and the handle 42.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A curved-type adjustable wrench having
a handle being curved and having
a first end;
a second end; and
a hanging hole formed through the first end of the handle and having a center point; and
an operating head formed on and protruding from the second end of the handle opposite to the hanging hole and having
a fixed jaw formed on and protruding from the second end of the handle and having
a top;
a bottom;
a vertical plane;
an inner side;
two side faces;
a sliding slot formed in the vertical plane of the fixed jaw and formed through the top and the bottom of the fixed jaw;
an opening hole being quadrate, formed though the side faces of the fixed jaw and communicating with the sliding slot and having a side; and
an operating face formed on the inner side of the fixed jaw, perpendicular to the vertical plane of the fixed jaw and paralleling with the side of the opening hole;
a movable jaw movably connected to the fixed jaw, facing the operating face of the fixed jaw and having
a rear side; and
an engaging rod formed on and protruding from the rear side of the movable jaw and sliding mounted in the sliding slot of the fixed jaw;
a thumbscrew rotatably mounted in the opening hole of the fixed jaw and extending into the sliding slot to engage the engaging rod of the movable jaw to adjust the distance between the fixed jaw and the movable jaw; and
wherein a horizontal extending line extends along the side of the opening hole of the fixed jaw, parallels with the operating face of the fixed jaw and is intersected with the vertical plane of the fixed jaw to form an intersection point, and an included angle is formed between the horizontal extending line and a line that is formed between the intersection point and the center point of the hanging hole, due to the horizontal extending line parallels with the operating face of the fixed jaw, an angle between the operating face of the fixed jaw and the handle is same as the included angle between the horizontal extending line and the line that is formed between the intersection point and the center point of the hanging hole and is 25˜40°.

2. The curved-type adjustable wrench as claimed in claim 1, wherein the handle has multiple recesses formed in the handle at intervals between the ends of the handle to reduce the whole weight of the handle.
